(19) United States
(12) Patent Application Publication
(10) Pub. No.: US 2026/0285217 A1
(43) Pub. Date: Sep. 24, 2026

(54) CARGO STRAP RETAINING CLIP

(71) Applicant: Justin BURDICK, Melba, ID (US)

(72) Inventor: Justin BURDICK, Melba, ID (US)

(21) Appl. No.: 19/566,895

(22) Filed: Mar. 13, 2026

Related U.S. Application Data
(60) Provisional application No. 63/774,048, filed on Mar. 18, 2025.

(51) Int. Cl. B60P 7/08

(52) U.S. Cl. CPC B60P 7/0807; B60P 7/0823

(57) ABSTRACT

A retaining clip removably couplable to a hook attached to one end of a cargo strap prevents accidental loss of strap retention when securing a load for transport. A magnet is embedded within a housing of the retaining clip, and channels formed on both sides of the housing frictionally engage the hook, such as a J-hook. The hook magnetically attaches the end of the cargo strap to a hauling surface, which frees an operator to handle, tension, and tie off an opposite end of the strap across the hauling surface.

### RELATED APPLICATIONS

The present application claims priority to U.S. Provisional App. 63/774,048 filed Mar. 18, 2025, the contents of which are fully incorporated herein by reference.

### BACKGROUND OF THE INVENTION

### Field of the Invention

The present invention relates generally to load securement devices, and more particularly, to retaining clips for securing a free end of a hooked cargo strap to allow for tightening of the cargo strap.

### Description of Related Art

Cargo straps, also commonly referred to as tie-down straps, are ubiquitous in the logistics and transportation industries for securing loads to trailers, roof racks, and truck beds. Conventional cargo strap systems are typically provided as a multi-component kit comprising a “fixed” short strap and a “lead” long strap. The short strap is generally equipped with a tensioning mechanism (e.g., a ratcheting drum or cam buckle) and a first terminal connector, such as a J-hook or S-hook. The long strap includes a second terminal connector at one end and a free “tail” end configured for integration with the tensioning mechanism.

The standard operational procedure requires a user to first anchor the terminal connector of the long strap to a tie-down point on one side of a transport platform. The user must then manually maintain tension on the strap while spanning it across the cargo to prevent the hook from slipping or disengaging from the anchor point due to gravity or shifting. Once the strap is positioned, the user must simultaneously hold the long strap in place, feed the free end into the tensioning hardware of the short strap, and anchor the short strap's hook to a second tie-down point.

A significant technical deficiency in these conventional systems is the reliance on continuous manual tension to maintain the mechanical coupling between the hooks and the anchor points during the “pre-tensioning” phase. Because the hooks are typically open-ended or rely on the tension of the strap to stay seated, any momentary slack—often caused by the user moving from one side of the vehicle to the other—results in the hook disengaging.

This problem is exacerbated in solo-operator environments. A solo operator must often navigate around large obstacles or climb onto the transport platform, during which time the “remote” hook (the hook furthest from the operator) frequently detaches. This leads to a repetitive and inefficient “reset” cycle, where the operator must walk back to re-engage the first hook, only to risk disengagement again while returning to the tensioning hardware. The difficulty increases proportionally with the length of the strap and the height of the load, as longer straps introduce more potential for slack and oscillate more easily. In industrial or commercial hauling applications requiring dozens of straps, these cumulative delays represent a substantial loss in operational efficiency and increase the physical burden on the operator.

There have been attempts to design cargo straps that resolve the above problems, such as that disclosed in U.S. Patent Publication 2006/0177282 (the “'282 Publication”). However, these proposed solutions have resulted in new problems and have proved unsatisfactory in the industry. For example, the '282 Publication teaches integrating a magnet into the hook of the cargo strap so that the hook maintains its position without the need for tension. A disadvantage of the '282 Publication's device is that it requires an entirely new cargo strap assembly because the magnetic hook is integrally connected to the strap. An operator would be required to replace all existing cargo straps with the one disclosed in the '282 Publication for the device to provide the desired relief. This would add significant cost to the operation, especially for fleets of vehicles that each have numerous straps for hauling large loads.

Thus, what is needed is a device that can be used with existing cargo straps to secure the hook of the long strap in place to allow the operator to freely and easily complete the strapping process without risk of the hook becoming disengaged or mislocated.

### SUMMARY OF THE INVENTION

The above problems can be resolved with a retaining clip according to the present invention. The inventive retaining clip is removably attachable to a hooked cargo strap and includes an embedded magnet to removably secure the hook of the cargo strap to a hauling surface. This allows an operator to set the hook on the hauling surface and engage the free end of the cargo strap to the tensioning mechanism without having to maintain constant tension on the strap to keep the hook in place. After securing one cargo strap, the operator can easily remove the retaining clip from the hook for use with subsequent cargo straps, allowing the operator to continue use of their existing cargo straps.

One embodiment of the present invention features a specialized clip for securing a hooked cargo strap to a hauling surface. The clip has a clip body with a top surface, a bottom surface, a front face, a rear surface, and a main housing formed between the front face and the rear surface. At least one channel is formed in the front face along a side of the main housing. The channel is designed to removably engage the hooked cargo strap and extends between the top surface and the bottom surface. More specifically, the channel engages an arm of the hook on the hooked cargo strap. A magnet is partially enclosed within the main housing.

In some embodiments, the channel includes an opening that receives the arm of the hook of the hooked cargo strap. The opening of the channel may be oriented in the same direction as the magnet. Preferably, a cavity is formed within the main housing, the cavity extending from the front face toward the rear surface. The magnet may be frictionally secured within the cavity. In some embodiments, the cavity may also include at least one finger extending from an edge of the cavity on the front face. The finger secures the magnet within the cavity. Some embodiments may employ a plurality of fingers, preferably arranged radially symmetrically around the cavity.

In some preferred embodiments, the channel has an outer wall, an inner wall, and an inner surface. The outer wall and inner wall both extend toward the inner surface to define an open face. Preferably, the inner wall forms part of the main housing, e.g., one side of the main housing. Preferably, the open face and the magnet are oriented in the same direction. The open face may be formed through the front face of the clip body. The channel may also include one or more tabs extending from the outer wall partially into the channel. One or more secondary tabs may extend from the inner wall partially into the channel. In preferred embodiments, the tabs and the secondary tabs are designed to engage the hooked cargo strap, i.e., an arm of the hook, removably secured within the channel.

Some alternative embodiments include both a first channel and a second channel, with a main housing that separates the first channel and the second channel. Preferably, a first side of the main housing forms the inner wall of the first channel and a second side of the main housing forms the inner wall of the second channel. Preferably, each channel extends at an angle, relative to a bilateral axis of the clip, from the top surface to the bottom surface. The angle may be substantially equal to 45-degrees. Preferably, the angle of each channel is such that the first and the second channels may simultaneously engage opposite arms of the hooked cargo strap.

In some embodiments, the channel may include one or more voids formed therein. The voids are designed to increase the flexibility of the channel to allow for flexing around an arm of the hooked cargo strap. Preferably, the magnet has a magnetic force of at least 25 pounds.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a perspective view of an embodiment of a retaining clip according to the present invention.

FIG. 2 is a front view of the embodiment of FIG. 1.

FIG. 3 is a rear view of an embodiment of a retaining clip according to the present invention.

FIG. 4 is a bottom end view of an embodiment of a retaining clip according to the present invention.

FIG. 5 is a top end view of an embodiment of a retaining clip according to the present invention.

FIG. 6 is a side view of an embodiment of a retaining clip according to the present invention.

FIG. 7 is a perspective view of a retaining clip according to the present invention engaged to an exemplary hooked cargo strap.

FIG. 8 is a perspective view of a retaining clip according to the present invention engaged to an exemplary hooked cargo strap in use with a hauling surface.

### DETAILED DESCRIPTION OF THE INVENTION

The following disclosure presents exemplary embodiments for a retaining clip that can be removably attached to the hook of a cargo strap to removably secure the hook to a hauling surface. A cargo strap deployed with the disclosed retaining clip maintains its position on the hauling surface thereby allowing the operator the freedom to tighten the strap in place without risk of the hook moving positions or otherwise disengaging from the hauling surface. The disclosed device thereby increases efficiency of the loading and securing process for cargo that is being transported.

The retaining clip according to the present invention can be quickly and easily attached to a variety of cargo strap types and magnetically secure the hook of the cargo strap to a surface. The retaining clip disclosed herein allows the operator freedom to position the strap over the load without having to worry about tensioning the strap to maintain hook engagement with the hauling surface, such as a trailer bed. Once the cargo strap is in its proper position for securing the load, the operator may complete the tensioning process to fully secure the load to the hauling surface. Thereafter, the operator may retrieve the retaining clip for use with the next strap. Alternatively, the retaining clip may be left in position until the operator removes the cargo strap from the load. In such case, multiple retaining clips may be used, one for each cargo strap.

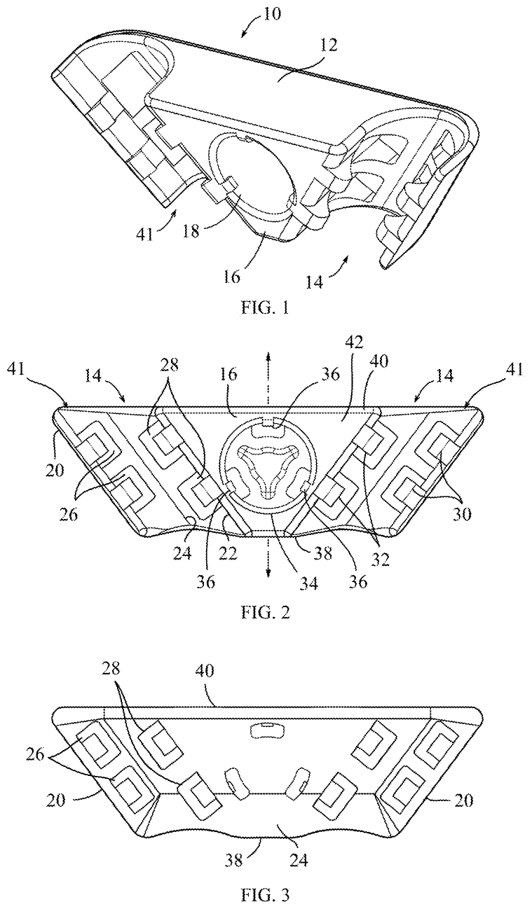

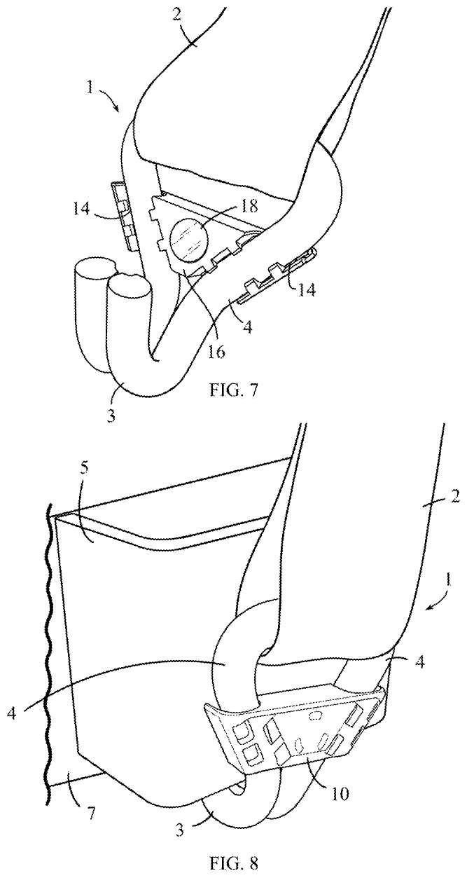

FIG. 1 is a perspective view of an embodiment of a retaining clip for a cargo strap according to the present invention. The retaining clip 10 includes a body 12 engineered to removably engage a hook 3. See FIG. 7. So engaged, the adjoined clip 10 and hook 3 can then be affixed to a cargo strap 2, and the hook 3 may then be removably secured to a hauling surface 7. See FIG. 8. The clip body 12 has at least one channel 14 and a main housing 16. Preferably, there are two channels 14, one formed on each side of the main housing 16. The channels 14 are configured to frictionally engage an arm of the hook 3 while positioning the main housing 16 substantially in the center of the hook between the arms 4. This allows the operator the freedom to deploy the hooked cargo strap without interference from the retaining clip 10 while ensuring the clip 10 is in proper position to engage the hauling surface 7. In some embodiments, only one channel 14 is formed alongside the main housing 16.

The main housing 16 has a magnet 18 at least partially enclosed therein, as described further below. When channels 14 of the retaining clip 10 are engaged to the hook 3 of a cargo strap 2, the magnet 18 removably secures both the clip 10 and the hook 3 to the hauling surface 7, such as a trailer bed, which is at least partially formed from a magnetic material such as carbon steel. The magnetic attachment ensures the hook will maintain its position on the hauling surface while freeing the operator to move around the hauling surface to the opposite end of the cargo strap 2 without having to continuously maintain tension in the strap. The operator can then complete the tensioning of the strap to secure the load without suffering a reset cycle.

FIG. 2 is a front view of an embodiment of the retaining clip 10 according to the present invention and FIG. 3 is a rear view of the retaining clip 10. The body 12 has a bottom surface 38, a top surface 40, a front face 42, and a rear surface 24. The main housing 16 extends between the bottom surface 38 and the top surface 40. Preferably, the main housing 16 is substantially centrally located between the two channels 14. Each of the two channels 14 preferably extend at an angle relative to the main housing 16, the angle being defined by a bilateral axis extending through the middle of the main housing 16 between the bottom 38 and top 40 of the clip body 12. The axis is shown by the dotted line marked in FIG. 2. In preferred embodiments, each channel 14 extends at a substantially 45-degree angle relative to the bilateral axis. In other embodiments, the angle of the channel 14 may be greater than or less than 45 degrees depending on the type of hook the retaining clip 10 is designed to engage. In further embodiments, the channels 14 may be substantially parallel to the bilateral axis.

Each channel 14 has an open face 41 to receive and frictionally engage the arm of the hook. The open face 41 of each channel 14 is oriented in the same direction as the magnet 18 and the front face 42. The open face 41 is formed by an outer wall 20 and an inner wall 22 extending from the back surface 24. Note, the back surface 24 of the body 12 forms the inner surface of each channel 14. Each inner wall 22 forms one side of the main housing 16. Due to the angle of each channel 14, the main housing 16 is generally triangular in shape, with the base of the triangle forming the top surface 40 of the body 12.

Preferably, each channel 14 includes at least one void 26, 28 defined in each of the outer wall 20 and inner wall 22, respectively. The voids 26 and 28 increase flexibility of the channels 14 to allow engagement with the arm of the hook. The voids 26 and 28 allow the outer walls 20 to flex outward when the arms of a hook are engaged to the channels 14. The voids 26 and 28 also reduce material used for the retaining clip 10 to reduce manufacturing costs. The width of the open face 41, defined as the distance between the outer edge of the outer wall 20 and the outer edge of the inner wall 22, for each channel 14 may be modified to accommodate different hook arm diameters and different sized cargo straps.

The main housing 16 separates the two channels 14 from one another. Preferably, the size of the main housing 16, and thus separation between the two channels 14, is selected to allow both channels 14 to simultaneously engage each arm of the hook. Thus, for large hooks, such as those used on a 4-inch cargo strap, the size of main housing 16 may be increased to ensure the channels 14 are properly positioned to engage each arm that forms the hook. Said another way, the retaining clip 10 can be scaled to accommodate various sizes of known cargo strap hooks.

The main housing 16 includes a cavity 34 defined therein, extending through the front face 42 toward the rear surface 24. The magnet 18 is housed within the cavity 34. The cavity 34 includes at least two tabs 36 extending radially inward from the perimeter of the cavity 34 on the front face 42. The magnet 18 is frictionally secured within the cavity 34, e.g., the outer diameter of magnet 18 may closely match the inner diameter of the cavity 34. The tabs 36 engage the magnet 18 within the cavity 34 to further secure the magnet 18 within the cavity. In some embodiments, an adhesive may be applied in the cavity 34 to further secure the magnet 18 therein. Preferably, a plurality of tabs 36 are positioned radially symmetrically around the cavity 34, e.g., there may be three tabs 36 placed every 120-degrees.

Preferably, the magnet 18 is a strong permanent disk or puck magnet having a magnetic force of at least 25 pounds. In some embodiments, the magnet 18 is a neodymium magnet. Other types of permanent magnets are also acceptable for use as magnet 18 and are included within the scope of the present invention.

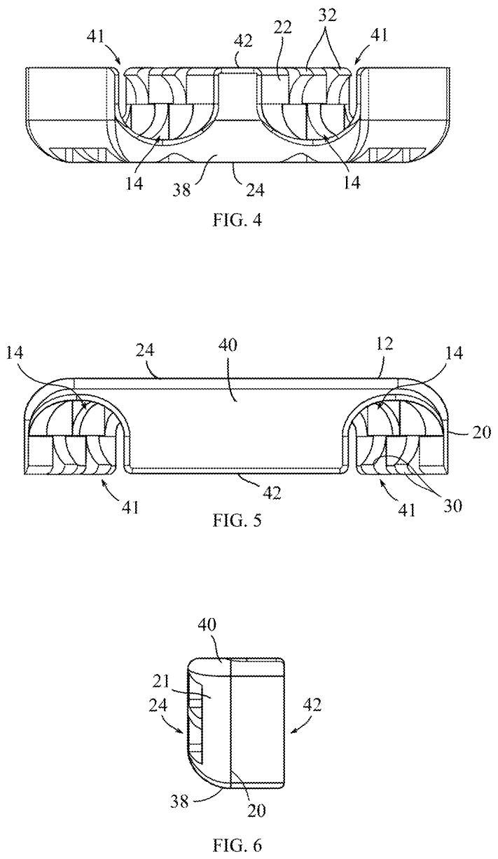

FIG. 4 is a bottom end view of the retaining clip 10 and FIG. 5 is a top end view of the retaining clip 10. In some embodiments, the channels 14 include a plurality of inwardly extending fingers or tabs configured to frictionally engage the arm of the hook. As can be seen in FIGS. 4-5, the outer wall 20 includes fingers 30 and the inner wall 22 similarly includes fingers 32. The fingers 30 and 32 each extend into the channel 14 from the respective walls 20 and 22. The fingers 30 and 32 aid in securing the retaining clip 10 to the arms of a hook on a cargo strap. Preferably, the arms of the hook are secured under the fingers 30 and 32 within the channel 14, as shown below in FIG. 7.

FIG. 6 is a side view of the retaining clip 10 according to the present invention. The outer wall 20 is preferably smooth and extends between the top surface 40 and the bottom surface 38. In some embodiments, each outer wall 20 has a rounded edge 21 between the front face 42 and the rear surface 24.

FIG. 7 is a perspective view of an embodiment of the retaining clip 10 engaged to a hooked cargo strap. FIG. 8 is a perspective view of the retaining clip 10, shown securing a hooked cargo strap to a hauling surface. The hooked cargo strap 1 has a strap 2 extending from the hook 3. The hook 3 has opposing arms 4 that are shaped into the hook 3 and interface with the strap 2. The hook 3 may be positioned to engage the hauling surface, such as by hooking into an anchor, eye-bolt, or other attachment interface 5 on the hauling surface 7. As shown in FIG. 7, each channel 14 engages an arm 4 of the hook 3. The main housing 16 is positioned between the arms 4. The magnet 18 is oriented to face the same direction as the hook 3 to ensure the hooked cargo strap 1 is secured in place on the hauling surface 7.

FIG. 8 illustrates how a retaining clip 10 can be used to secure the hooked cargo strap 1 to a hauling surface 7. Note, the hauling surface 7 is only partially shown, as a full rendering of a trailer or other hauling surface is not necessary to understand the scope of the invention. By way of example and not limitation, some examples of a hauling surface 7 include the flat surface of a flatbed trailer; a sidewall of a flatbed trailer, a sidewall of a truck, van, tractor, or boat; or a bracket, fence, bar, or other retaining structure attached to any of the foregoing vehicles. The retaining clip 10 magnetically secures the hook 3 of the cargo strap 1 to an attachment interface 5, such as an anchor point on hauling surface 7. Attachment interface 5 is commonly made from carbon steel that is welded or bolted to the hauling surface 7. As such, attachment interface 5 has magnetic properties that will allow the magnet 18 to be secured thereto, with sufficient strength to hold the hook 3 in its engaged relationship with the attachment interface 5. The strap 2 remains free without tension applied thereto. The retaining clip 10 magnetically secures the hook 3 in place on the hauling surface 7. Without the retaining clip 10 present to hold the hooked cargo strap 1 in place, the cargo strap would simply fall out of place unless sufficient tension is applied and maintained to hold the hook 3 at the attachment interface 5.

The retaining clip 10 according to the present invention therefore saves an operator time and energy when initially securing a load to a hauling surface. The retaining clip 10 can be quickly deployed to position the strap and thereafter removed from the tightened strap to be used with the next cargo strap. The retaining clip 10 can be attached to various types of standard hooks on an existing cargo strap, e.g., J-hooks, double J-hooks or wire hooks, S-hooks, chain anchors, etc., alleviating the need for an operator to purchase a specialized cargo strap. Rather, the retaining clip 10 can be fit as an aftermarket addition to existing cargo straps, saving an operator time and money by not having to change out their existing equipment.

In some preferred embodiments, the retaining clip 10 is injection molded using one or more polymer materials according to conventional injection molding processes. Some non-limiting examples of polymer materials that may be suitable for injection molding of the retaining clip 10 according to the present invention include: polyamides, polyimides, polyesters, polycarbonates, polysulfones, polylactones, polyacetals, acrylonitrile/butadiene/styrene copolymer resins, polyphenylene oxides, ethylene/carbon monoxide copolymers, polyphenylene sulfides, polystyrene, styrene/acrylonitrile copolymer resins, styrene/maleic anhydride copolymer resins, aromatic polyketones and mixtures thereof.

Particularly suitable materials for injection molding of the retaining clip 10 according to the present invention include polycarbonates or polyamides, such as nylon. The materials selected for injection molding of the retaining clip 10 should provide structural integrity while being pliable to allow sufficient flexibility of the molded parts. Polycarbonate materials are particularly well suited for molding of the retaining clip 10 because the molded parts will be sufficiently pliable while maintaining the necessary strength and rigidity to handle normal working conditions.

In other embodiments, the retaining clip 10 may be formed from metal, preferably a non-magnetic metal such as aluminum, copper, tin, brass, titanium, zinc, or bronze. In alternative embodiments, the retaining clip 10 may be injection molded using one or more metallic powders, or a combination of polymer and metallic powders. In another embodiment, the retaining clip 10 is formed entirely of a magnetic material and magnet 18 is not present as a separate component of the clip structure.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A clip for securing a hooked cargo strap to a hauling surface, comprising:
a clip body having a top surface, a bottom surface, a front face, a rear surface and a main housing formed between the front face and the rear surface;
at least one channel formed in the front face along a side of the main housing and configured to removably engage the hooked cargo strap, the at least one channel extending between the top surface and the bottom surface; and
a magnet partially enclosed within the main housing.

2. The clip of claim 1, wherein the at least one channel comprises an opening configured to receive the hooked cargo strap.

3. The clip of claim 1, wherein the main housing comprises a cavity formed within the clip body and extending from the front face to the rear surface, the cavity configured to frictionally engage the magnet.

4. The clip of claim 3, wherein the cavity further comprises at least one finger extending from an edge, on the front face, into the cavity, the at least one finger configured to secure the magnet within the cavity.

5. The clip of claim 4, comprising a plurality of fingers formed radially symmetrical around the cavity.

6. The clip of claim 1, wherein the at least one channel comprises an outer wall, an inner wall and an inner surface, the outer wall and the inner wall extending toward the inner surface defining an open face and the inner wall forming part of the main housing.

7. The clip of claim 6, wherein the open face and the magnet are oriented in a common direction.

8. The clip of claim 6, wherein the open face is formed through the front face.

9. The clip of claim 6, further comprising one or more tabs extending from the outer wall into the at least one channel.

10. The clip of claim 9, further comprising one or more secondary tabs extending from the inner wall into the at least one channel.

11. The clip of claim 10, wherein the tabs and the secondary tabs are configured to engage the hooked cargo strap secured within the at least one channel.

12. The clip of claim 1, wherein the at least one channel comprises a first channel and a second channel.

13. The clip of claim 12, wherein the main housing separates the first channel from the second channel.

14. The clip of claim 13, wherein the main housing has a first side forming an inner wall of first channel and a second side forming the inner wall of the second channel.

15. The clip of claim 14, wherein the first channel and the second channel extend at an angle, relative to a bilateral axis, from the top surface to the bottom surface.

16. The clip of claim 15, wherein the angle is substantially equal to 45 degrees.

17. The clip of claim 15, wherein the angle of the first channel and the second channel is configured such that the first channel and the second channel simultaneously engage opposite arms of the hooked cargo strap.

18. The clip of claim 1, further comprising one or more voids formed in the at least one channel.

19. The clip of claim 15, wherein the one or more voids are configured to increase flexibility of the at least one channels to allow flexing around a hook of the hooked cargo strap.

20. The clip of claim 1, wherein the magnet is a permanent magnet having a magnetic force of at least 25 pounds.
